(19) United States
(12) Patent Application Publication
(10) Pub. No.: US 2011/0113778 A1
(43) Pub. Date: May 19, 2011

(54) Apparatus and method for using solar power in existing power plants

(76) Inventors: Lucien y. Bronicki, Yavne (IL); Joseph Sinai, Or-Yehuda (IL)

(21) Appl. No.: 12/591,317

(22) Filed: Nov. 16, 2009

(51) Int. Cl. F03G 6/04

(52) U.S. Cl. 60/641.14

(57) ABSTRACT

Disclosed is a method and an apparatus for generating power using a synthetic gas/natural gas mixture comprising: a) an expander for expanding a hydrocarbon gas from a pipeline and forming an expanded hydrocarbon gas; b) supply means for supplying said expanded hydrocarbon gas to a medium temperature reformer; a) equipment constructed and arranged to reform said expanded hydrocarbon gas from said pipeline into a synthetic gas/natural gas mixture using solar radiation, said equipment including said medium temperature solar reformer and a steam generator generating steam using heat from the medium temperature reformer; d) further supply means for supplying said synthetic gas/natural gas mixture produced by said equipment to a compressor for compressing said mixture and forming a compressed mixture; and e) a still further supply means for supplying said compressed mixture to said pipeline.

This subject matter relates to an apparatus and method for using solar power in existing power plants without the need for new lines or electricity storage.

Because of the problem of global warming, the finite supply of fossil fuels, and the stigma associated with the use of nuclear energy, interest exists in developing equipment and processes that rely on renewable energy sources, and in particular, solar energy, for power generation. Probably many decades will pass, however, before the switch from fossil fuels is complete.

Existing solar power generation equipment is expensive, and has difficulty dealing with the intermittent availability of solar radiation. This intermittent availability makes the network unstable. Solar power generation is therefore usually combined with either storage of an energy source to provide continuous power when solar radiation is unavailable, or used with dedicated transmission lines to transport the power as it becomes available. While dedicated storage and/or dedicated transmission lines help solve the problem of the intermittent availability of solar radiation, both are expensive.

There is therefore a need to reduce the costs as well as the time involved in switching to solar-based power plants by taking advantage of current resources and utilizing equipment based on solar technology. A way to reduce costs is to use solar energy to produce synthetic gas (syngas) in conjunction with a natural gas pipeline, integrating the syngas into the network. By integrating the syngas into the natural gas pipeline, the solar energy captured in the syngas is utilized with the energy in the natural gas when converted to electricity. This will permit the gradual replacement of existing fossil fueled power plants with minimal risk and reduced capital expenses.

### SUMMARY

An aspect of the present subject matter is directed to an apparatus for generating power using a synthetic gas/natural gas mixture comprising: a) an expander for expanding a hydrocarbon gas from a pipeline and forming an expanded hydrocarbon gas; b) supply means for supplying said expanded hydrocarbon gas to a medium temperature reformer; a) equipment constructed and arranged to reform said expanded hydrocarbon gas from said pipeline into a synthetic gas/natural gas mixture using solar radiation, said equipment including said medium temperature solar reformer and a steam generator generating steam using heat from the medium temperature reformer; d) further supply means for supplying said synthetic gas/natural gas mixture produced by said equipment to a compressor for compressing said mixture and forming a compressed mixture; and e) a still further supply means for supplying said compressed mixture to said pipeline.

Another aspect of the present subject matter is drawn to a method of generating power using synthetic gas comprising: a) expanding a hydrocarbon gas from a pipeline to form an expanded hydrocarbon gas; b) supplying said expanded hydrocarbon gas to a medium temperature reformer, c) reforming at least a portion of the expanded hydrocarbon gas into a synthetic gas/natural gas mixture using equipment constructed and arranged to reform said hydrocarbon gas from said pipeline into a synthetic gas/natural gas mixture using solar radiation, said equipment including said medium temperature solar reformer and a steam generator generating steam using heat from the medium temperature reformer; d) compressing the synthetic gas/natural gas mixture to form a compressed mixture; and e) supplying the compressed mixture to said pipeline.

A further aspect of the present subject matter is directed to an apparatus for generating power using a synthetic gas/natural gas mixture comprising: a) a compressor for compressing a hydrocarbon gas from a pipeline and forming a compressed hydrocarbon gas; b) supply means for supplying said compressed hydrocarbon gas from the compressor to a medium temperature solar reformer; c) equipment constructed and arranged to solar reform said compressed hydrocarbon gas from said pipeline into a synthetic gas/natural gas mixture, said equipment including said medium temperature solar reformer and a steam generator generating steam using heat from the reformer equipment; d) further supply means for supplying said synthetic gas/natural gas mixture produced by said equipment to an expander to produce an expanded synthetic gas/natural gas mixture; and e) a still further supply means for supplying said expanded mixture to said pipeline.

A still further aspect of the present subject is drawn to a method of generating power using a synthetic gas/natural gas mixture comprising: a) compressing a hydrocarbon gas from a pipeline to form a compressed hydrocarbon gas; b) supplying said compressed hydrocarbon gas to a medium temperature solar reformer; c) reforming at least a portion of the compressed hydrocarbon gas into a synthetic gas/natural gas mixture using equipment constructed and arranged to reform said hydrocarbon gas from said pipeline into a synthetic gas/natural gas mixture using solar radiation, said equipment including said medium temperature solar reformer and a steam generator generating steam using heat from the medium temperature reformer; d) expanding the synthetic gas/natural gas mixture to form an expanded mixture; and e) supplying the expanded mixture to said pipeline.

A description of the present subject matter including various embodiments thereof is presented with reference to the accompanying drawings, the description not meaning to be considered limiting in any matter, wherein:

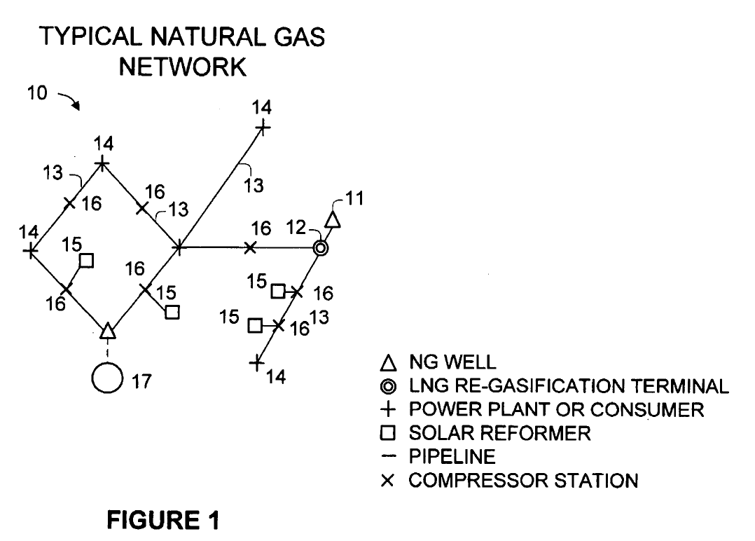

FIG. 1 illustrates a typical natural gas network;

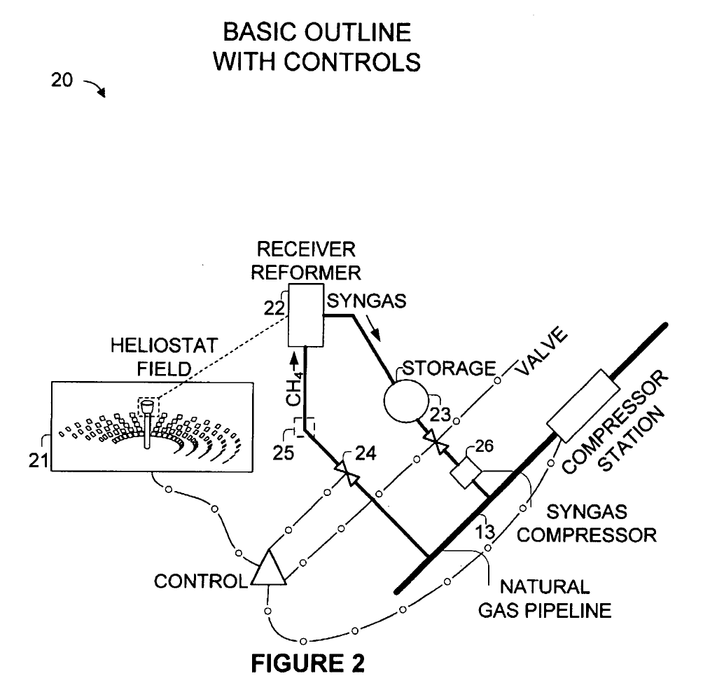

FIG. 2 illustrates a solar receiver/reformer system along a natural gas network;

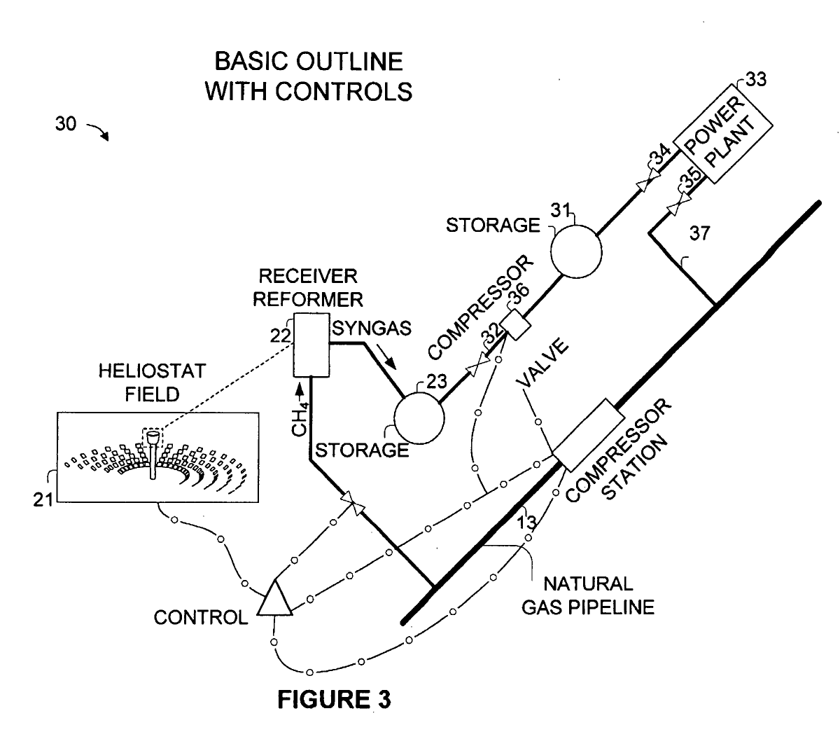

FIG. 3 illustrates an exemplary power generation system having a syngas storage capacity;

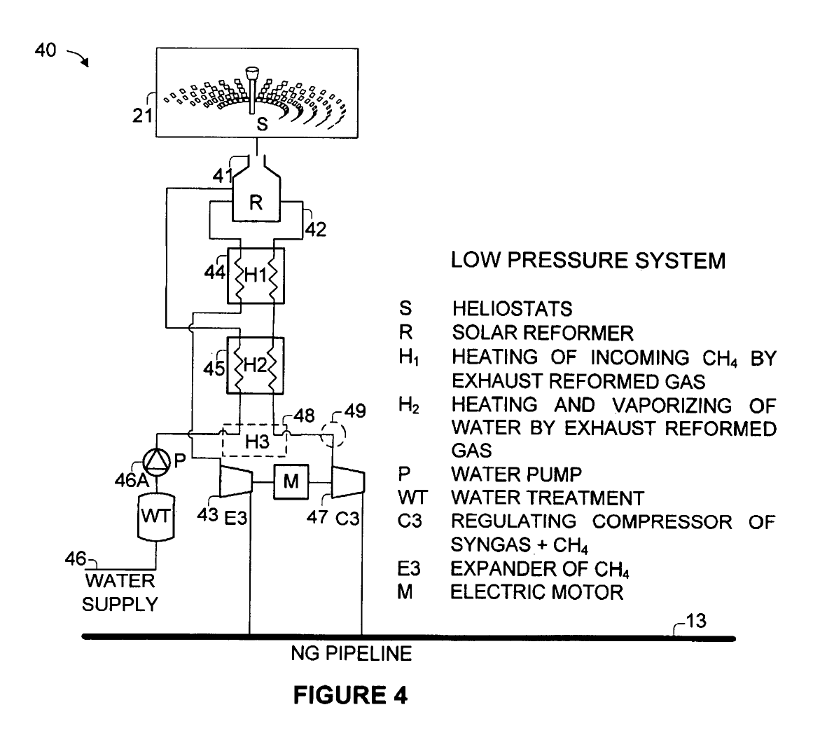

FIG. 4 illustrates an exemplary embodiment of medium temperature solar reformer equipment;

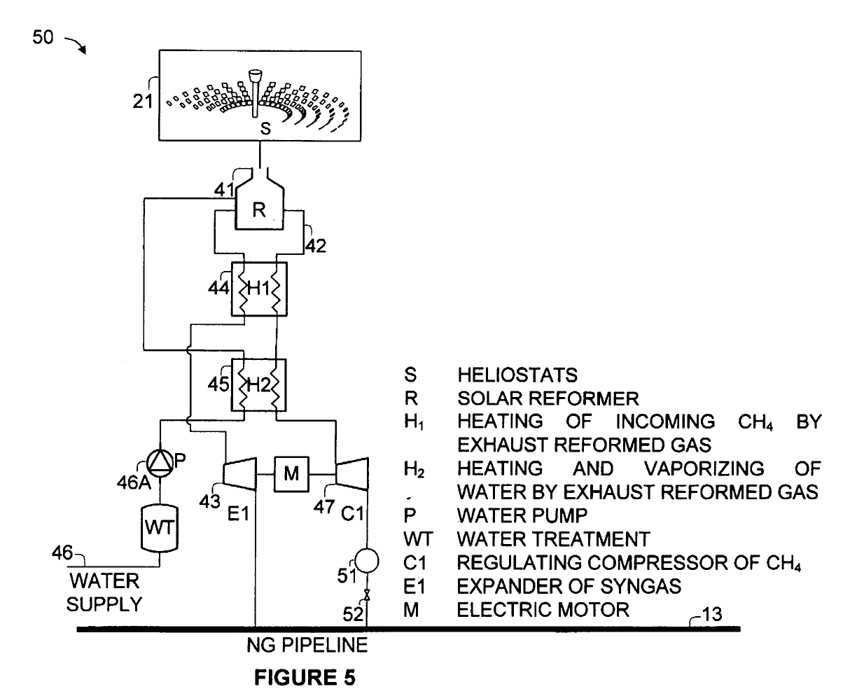

FIG. 5 illustrates a second exemplary embodiment of medium temperature solar reformer equipment;

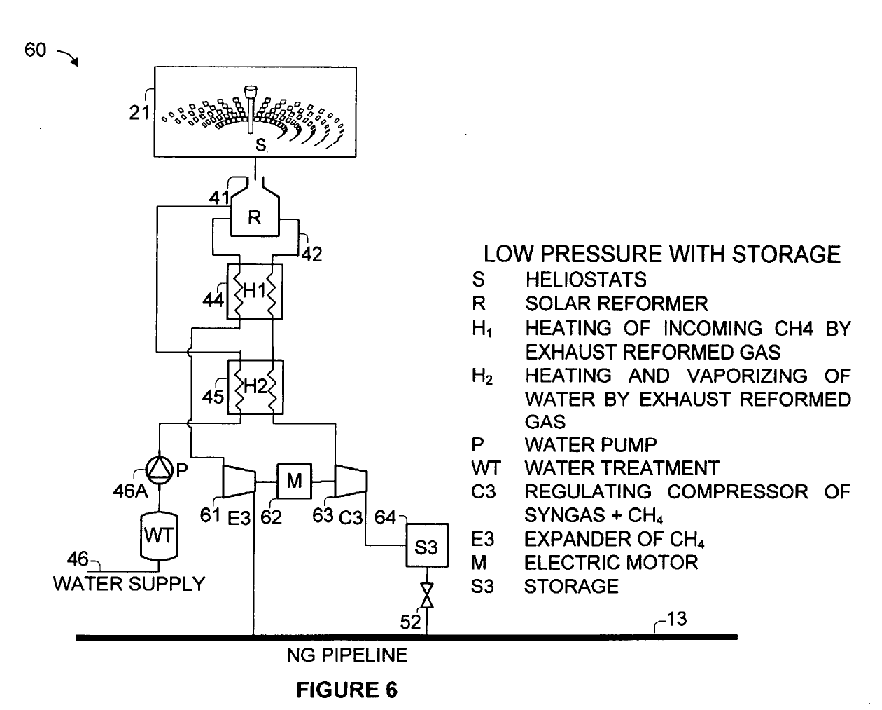

FIG. 6 illustrates a variation of the embodiment illustrated in FIG. 4;

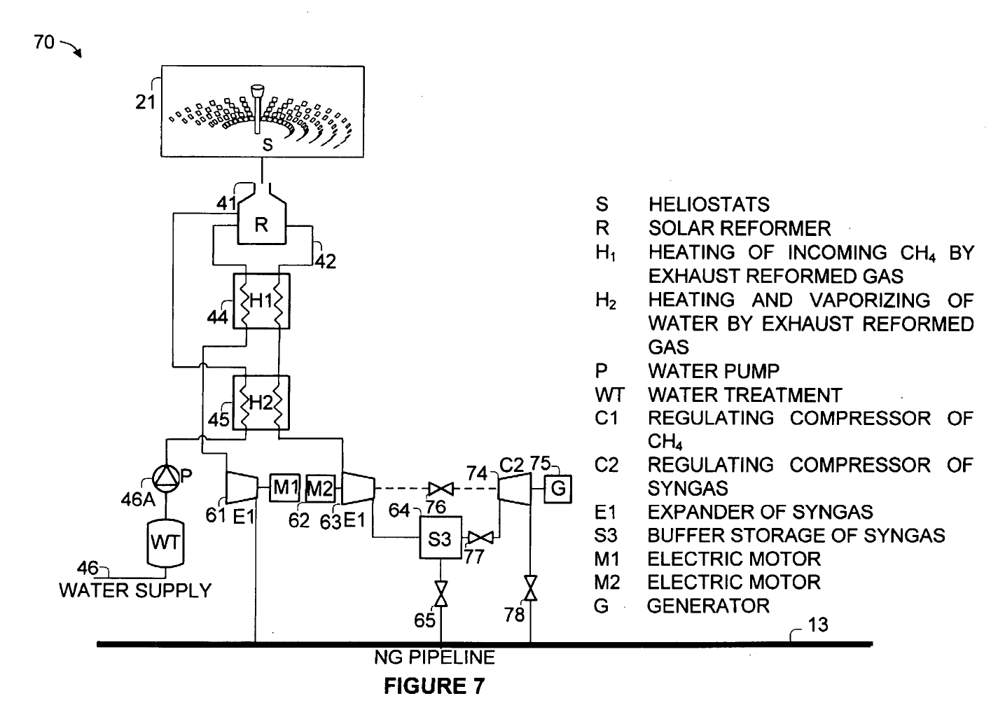

FIG. 7 illustrates a variation of the embodiment illustrated in FIG. 5;

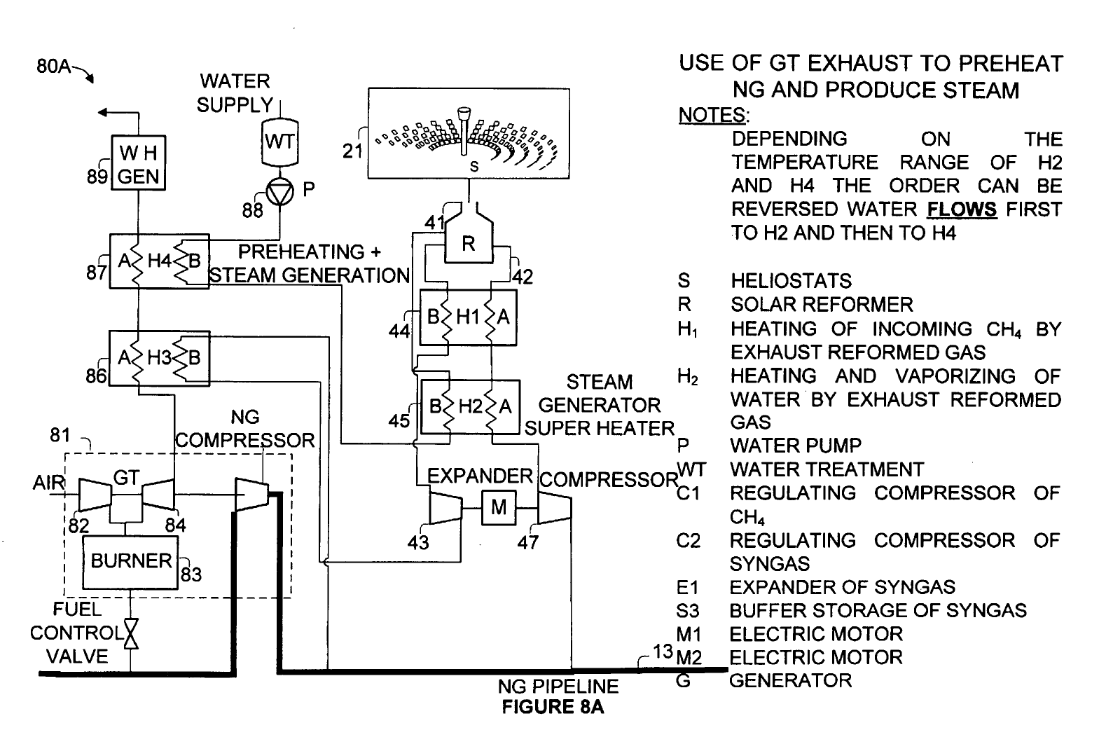

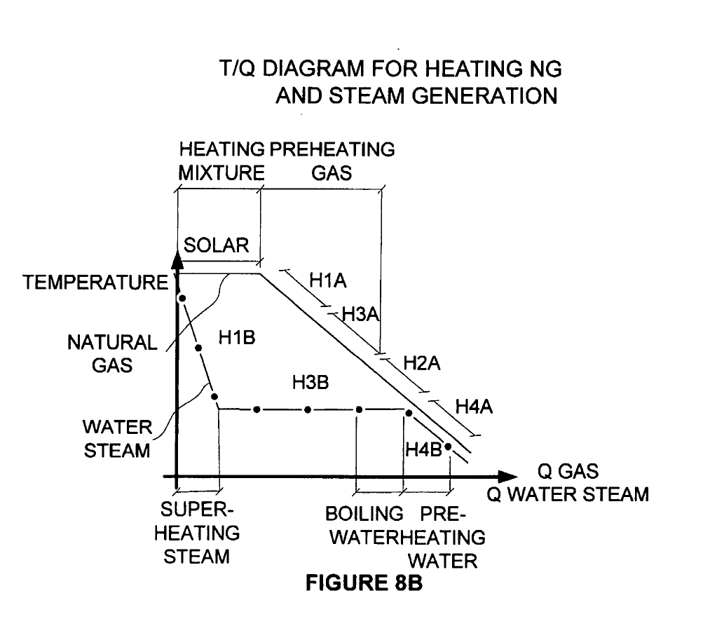

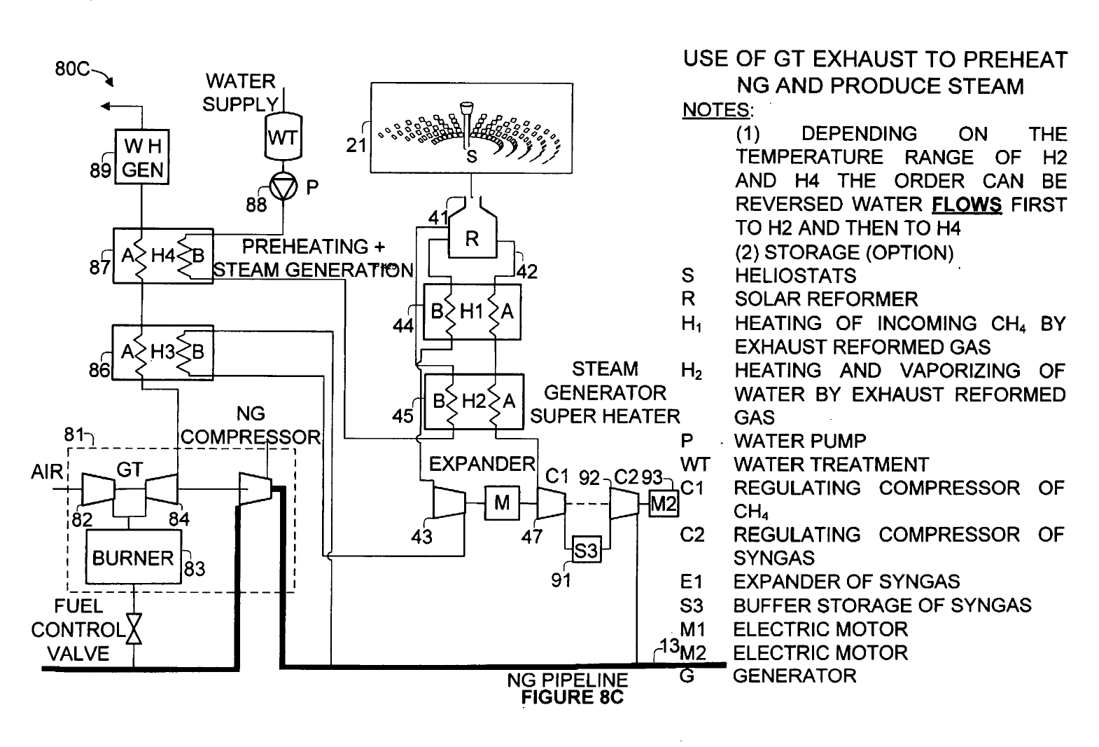

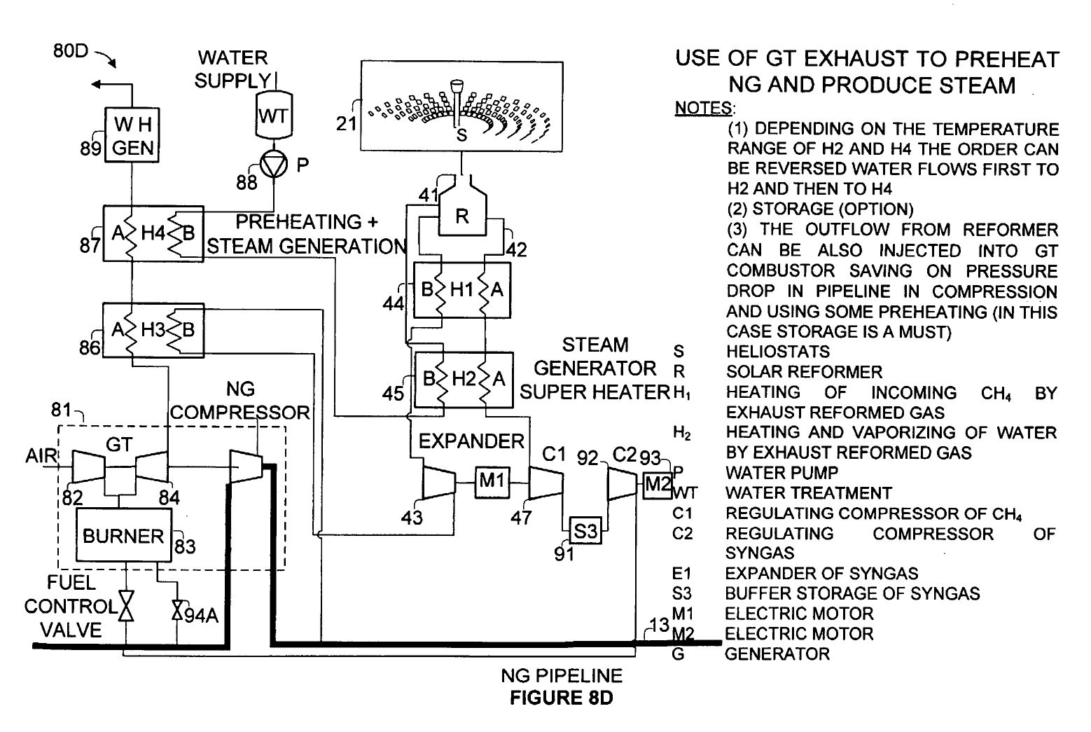

FIGS. 8A-8D illustrate expanded embodiments using gas turbine exhaust to heat natural gas and produce steam;

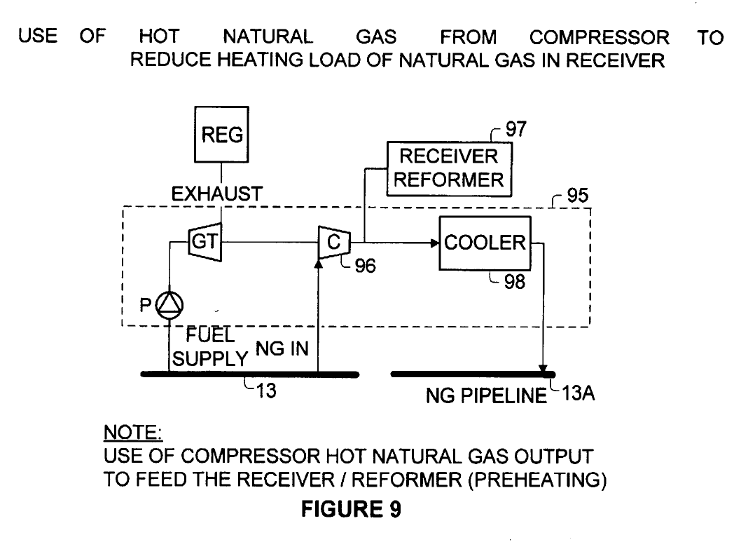

FIG. 9 illustrates an embodiment of the subject matter using hot natural gas from a compressor to reduce the heating load of the receiver; and

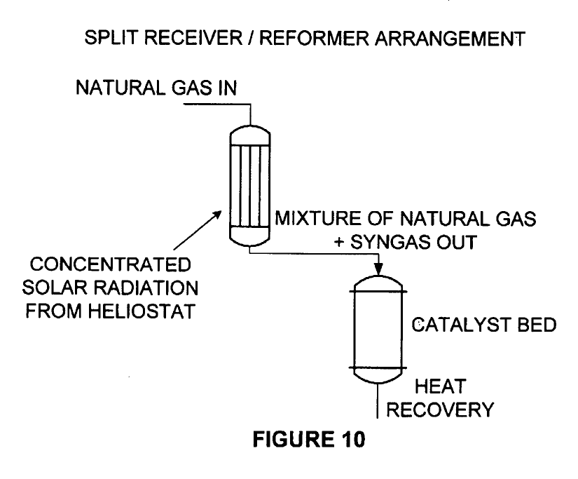

FIG. 10 illustrates an embodiment of the subject matter having a split receiver and reformer.

Similar reference numerals and designators in the various figures refer to like elements.

Referring to the drawings, FIG. 1 illustrates an exemplary typical natural gas network 10. The natural gas network has at least one gas well 11 or at least one liquid natural gas terminal 12. Natural gas is transported in this network using at least one natural gas pipelines 13, which supplies gas to one or more power plants 14 and/or solar reformers 15 along the natural gas pipelines. This embodiment also has an optional storage 17, which is shown near the natural gas well, but need not be. In the embodiment shown, each reformer 15 is associated with a compressor station 16, which compresses the reformed mixture up to the pressure level of the pipeline (e.g. about 500 psi). Additional compressor stations 16 are located along the natural gas pipeline 13, but need not be.

FIG. 2 illustrates an exemplary solar receiver/reformer system 20 along a natural gas pipeline 13. As shown in FIG. 2, a heliostat field 21 supplies solar thermal energy to a receiver/reformer 22 to use heat from the solar radiation to drive an endothermic chemical reaction between a hydrocarbon feedstock and steam or carbon dioxide in the presence of a catalyst. This reaction produces a mixture commonly referred to as synthetic gas or syngas. In the example shown, the hydrocarbon feedstock is supplied from natural gas pipeline 13 via pressure control valve 24, as pressure within the pipeline 13 is variable. The hydrocarbon feedstock may also pass through optional expander 25 before entering the receiver/reformer 22. In the example shown, the reformer operates at about 800° C. to about 900° C. to maximize conversion of the natural gas into syngas.

The syngas that is produced may be placed in storage 23, and/or compressed in compressor 26 and fed back into natural gas pipeline 13. In the embodiment shown, the syngas is only placed into natural gas pipeline 13 when the pipeline is idle, so as not to mix the syngas with natural gas. Mixing syngas with natural gas is avoided in this embodiment, as too high a quantity of syngas with the natural gas would require retrofitting the pipeline and power plant equipment due to the different thermodynamic properties of the gases.

FIG. 3 illustrates an exemplary dual gas power generation system 30 having optional syngas storage 23 and 31. Optional storage 23 and 31 are in addition to what is shown in FIG. 1. In the embodiment of FIG. 3, power plant 33 receives syngas from one or more of optional storages 23 and 31. If used, storage 31 receives syngas from syngas pipeline 32 after the syngas is compressed by compressor 36. The compressed syngas is fed into power plant 33 via valve 34. The power plant 34 may also receive natural gas from pipeline 13 via line 37 and valve 35. Valves 34 and 35 are required because, as mentioned above, the power plant requires retrofitting if it is to operate using a high percentage of syngas. Therefore power plant 33 uses valves 34 and 35 to control whether the plant receives syngas or natural gas. Valve 35 may optionally be used to reduce the pressure of the natural gas supplied to the plant to a pressure below the pressure of the natural gas in the pipeline. If the plant operates using syngas and natural gas at the same time, valves 34 and 35 are configured to ensure that syngas is only delivered to turbines retrofitted for high percentages of syngas, with natural gas delivered to the remaining turbines.

FIG. 4 shows an exemplary embodiment of a low pressure medium-temperature solar reformer system 40. This embodiment is also referred to as an energy recovery system 40. In system 40, solar reformer 41 operates at about 500° C. to about 600° C. to partially reform (in the limits tolerated by a gas turbine, compressor and pipeline) a hydrocarbon gas into a synthetic gas (syngas)/hydrocarbon gas mixture of up to about 30% syngas. Applicants have unexpectedly discovered that conventional turbines can run on a syngas/hydrocarbon mixture having up to about 30% syngas without having to retrofit the power plant turbines. When operated at temperatures between about 500° C. and about 600° C. or even 800° C., the solar reformer 41 produces a syngas/hydrocarbon gas mixture of up to about 30% hydrogen-enriched synthetic gas. At this concentration, the reformed hydrogen enriched syngas has about 30% higher heat energy than the original feedstock.

System 40 is therefore built with equipment constructed and arranged to reform at least a portion of a hydrocarbon feedstock into a synthetic gas/hydrocarbon gas mixture in solar reformer 41. Solar reformer 41 contains a catalyst and a condenser (not shown). Solar radiation may be directed to solar reformer 41 using one or more heliostats 21. Hydrocarbon feedstock passes into reformer 41 and is responsive to solar radiation and steam. In the embodiment of FIG. 4, the feedstock is natural gas from pipeline 13. The feedstock can also come from one or more other sources, such as an LNG terminal, LPG, biogas produced from anaerobic digestion, landfill gas, gas produced from a fermentation process, gas produced from a pyrolysis system, gas produced from a gasification system, etc. The feedstock reformer can also be a solid or liquid carbonaceous material such as coal, biomass, oil shale, oil residue, petcoke, asphaltenes, etc. Solar reformer 41 could optionally be replaced by a biomass gasifier (not shown), with the rest of the system remaining as described above. At least a portion of the hydrocarbon feedstock reforms into a mixture of hydrogen and carbon monoxide (syngas), with the mixture exiting solar reformer 41 via line 42.

In the non-limiting exemplary embodiment shown in FIG. 4, natural gas is drawn from pipeline 13 and passed through an expander 43 upstream of solar reformer 41. Placing expander 43 upstream of the solar reformer 41 lowers the pressure of the natural gas entering the reformer 41, which in turn increases the conversion yield of the reformation process, as conversion yield is higher at lower pressures. Placing expander 43 before reformer 41 may also enable recovery of additional heat energy from the power generation cycle, described in FIG. 8A below. After passing through expander 43, the natural gas is preheated in heat exchanger 44 (H1), which receives at least a portion of its heat from the high medium temperature syngas/natural gas mixture exiting solar reformer 41 via line 42. Heat exchanger 44 produces heated natural gas and a partially heat-depleted syngas/natural gas mixture.

The heated natural gas is then mixed with steam in solar reformer 41 to produce the syngas/natural gas mixture. Steam is produced in heat exchanger 45 from water in water supply 46. The water is fed to heat exchanger 45 (H2) via pump 46A. Pump 46A increases the pressure of the water supply to the pressure of reformer 41 prior to converting the water to steam, making the reformation process more energy efficient. Pump 46A also pumps in sufficient water to ensure there is enough steam in reformer 41 to avoid carbonization of the natural gas during the reformation process.

The water is heated into steam in heat exchanger 45 by the partially heat-depleted syngas/natural gas mixture exiting heat exchanger 44 (H1), and in certain embodiments is heated into superheated steam in heat exchanger 45 by the partially heat-depleted syngas/natural gas mixture. The partially heat-depleted syngas/natural gas mixture is further heat-depleted as it exits heat exchanger 45 (H2). Upon exiting heat exchanger 45, the further heat-depleted syngas/natural gas mixture is compressed in compressor 47 (C3), which optionally receives at least a portion of its energy from expander 43. The embodiment shown may optionally have heat exchanger 48 (H3), which preheats the water from water supply 46 using some of the remaining heat of the further heat-depleted syngas/natural gas mixture exiting heat exchanger 45. Heat exchanger 48 also condenses the excess water in the syngas stream, which was supplied to reformer 41 to prevent carbonization of the natural gas in reformer 41 during the reformation process.

The further heat-depleted syngas/natural gas mixture exiting heat exchanger 45 is compressed by compressor 47, forming a compressed syngas/natural gas mixture. The compressed syngas/natural gas mixture is then supplied to pipeline 13. The mixture may optionally be stored in low pressure storage 49 prior to being compressed in compressor 47 to approximately the pressure of the natural gas pipeline 13.

FIG. 5 illustrates another exemplary embodiment of a low pressure medium-temperature solar reformer system 50. In this embodiment, the compressed syngas/natural gas mixture is fed into buffer storage unit 51, which then feeds into pipeline 13 via valve 52. Having storage at the production site helps mitigate the effects of any surges in composition and/or flow of the syngas/natural gas mixture produced. Storage could also be used on both ends of pipeline 13, allowing pumping of the syngas/natural gas mixture in either direction when the natural gas pipeline is idle. Alternatively, the syngas/natural gas mixture could be pumped in a separate pipeline (not shown) on the same right of way, to be used alone or in conjunction with natural gas pipeline 13. The remaining details of FIG. 5 are the same as in FIG. 4, and are not repeated here.

FIG. 6 illustrates still another exemplary embodiment of a medium-temperature solar reformer system 60. This embodiment is similar to the FIG. 4 embodiment, but operates at a relatively high reformer pressure and temperature (with use of a suitable catalyst) and includes high pressure storage 64 (S3). Expander 61 (E3) expands the natural gas from pipeline 13 prior to feeding it to heat exchanger 44 (H1), and also drives motor 62 to power compressor 63. Compressor 63 receives the further heat-depleted syngas/natural gas mixture from heat exchanger 45 and produces a compressed syngas/natural gas mixture. Compressor 63 is located downstream of heat exchanger 45 (H2) and compresses the syngas/natural gas mixture to the pressure of natural gas pipeline 13 (e.g. about 500 psi depending on the pipeline used). The mixture may be held in high pressure storage 64 for later release into pipeline 13 via valve 65, or may be pumped directly into the pipeline. As indicated above, having storage at or near the production site helps mitigate the effects of any surges in composition and/or flow of syngas/natural gas mixture produced by solar reformer 41.

FIG. 7 illustrates a still further exemplary embodiment of a medium-temperature solar reformer system 70. The embodiment of FIG. 7 is similar to the embodiment of FIG. 6, but adds second expander 74 (E2) and generator 75. Expander 74 is configured to a receive syngas/natural gas mixture, natural gas, or both. For example, in one mode of operation expander 74 receives compressed syngas/natural gas from compressor 63 via valve 76. The output of compressor 63 may pass directly to expander 74, but need not. A portion of the compressor output may also be stored in high pressure storage 64 (S3). Alternatively, the syngas/natural gas mixture is supplied to expander 74 from high pressure storage 64 via valve 77. Expander 74 may also be supplied from natural gas pipeline 13 via valve 78.

This embodiment is exemplary only, and not limited to what is shown. For example, in still other embodiments, storage could be used on both ends of pipeline 13, allowing pumping of the syngas/natural gas mixture in either direction when the natural gas pipeline is idle. Alternatively, the syngas/natural gas mixture could be pumped in a separate pipeline on the same right of way, to be used in conjunction with the natural gas in any of the exemplary embodiments described herein.

FIGS. 8A-8D illustrate expanded embodiments of the subject matter of FIG. 4 using gas turbine exhaust to heat natural gas and produce steam. In FIG. 8A, a power plant 80A includes gas turbine unit 81 (sometimes referred to as a compressor station) having compressor 82 for compressing ambient air to produce compressed air that is applied to burner 83. Natural gas from pipeline 13 also feeds into burner 83, where combustion takes place. The combustion heats the compressed air and produces heated compressed air which is supplied to gas turbine 84 coupled to compressor 82 and a generator (not shown). Turbine 84 expands the heated compressed air and drives compressor 82 and produces hot exhaust gases. The compressor station may be manually attended, but need not be. If the compressor station includes a steam turbine, however, the station is manually attended 24 hours a day.

Gas turbine 84 also drives compressor 85 in natural gas pipeline 13, and can be located on a same drive shaft as compressor 85. Thus, energy from gas turbine 84 is used to drive compressor 85. The hot exhaust gases from gas turbine 84 are used to preheat and heat a working fluid (for example, organic working fluid) and may also be used to heat and preheat the natural gas reformed to create the syngas/natural gas mixture in reformer 41. An exemplary description of the reformation process is provided in the detailed description of FIG. 4, and is not repeated here.

After exiting reformer 41, the syngas/natural gas mixture is supplied via line 42 to heat exchanger 44, where a portion of the heat from the syngas/natural gas mixture is used to heat the natural gas prior to being supplied to reformer 41. Heat exchanger 44 produces a heat-depleted syngas/natural gas mixture that is supplied to heat exchanger 45. The heat-depleted syngas/natural gas mixture is supplied to heat exchanger 45, where heat from the heat-depleted syngas/natural gas mixture is used to produce super heated steam supplied to reformer 41 and a further heat-depleted syngas/natural gas mixture in heat exchanger 45. The further heat-depleted mixture is then compressed in compressor 47 prior to being fed to pipeline 13.

Although not shown, the embodiment of FIG. 8A may optionally have a fifth heat exchanger, which preheats the water from water supply 46 using some of the remaining heat of the further heat-depleted syngas/natural gas mixture exiting heat exchanger 45. This fifth heat exchanger also helps condense excess water remaining in the syngas stream, which was supplied to prevent carbonization of the natural gas in reformer 41 during the reformation process.

After exiting turbine 84, the hot exhaust gases are supplied to heat exchanger 86 (H3). Heat exchanger 86 receives the hot exhaust gases and natural gas from the pipeline, and produces a preheated compressed hydrocarbon gas (natural gas in the embodiment shown) and heat-depleted exhaust gases. The heat-depleted exhaust gases are supplied to heat exchanger 87 (H4). The order that the water passes through heat exchangers 45 (H2) and 87 (H4) can be reversed, depending on the temperature ranges of the two heat exchangers. In the embodiment shown here, heat exchanger 87 receives the heat-depleted exhaust gases and also receives water from pump 88, forming preheated water and steam and a further heat-depleted gas turbine exhaust. Pump 88 increases the pressure of the water supply to the pressure of reformer 41, making the reformation process more energy efficient. Pump 88 also pumps in sufficient water to ensure there is enough steam in reformer 41 to avoid carbonization of the natural gas during the reformation process.

After exiting heat exchanger 87, at least a portion of the heat remaining in the hot exhaust gases is utilized in waste-heat recovery unit 89. Waste-heat recovery unit 89 can be used in conjunction with reformer 41, and may also be used when the reformer is not operating. In waste-heat recovery unit 89, at least one heat exchanger (not shown) containing a working fluid receives the exhaust gases. The exhaust gases flow through the heat exchanger coils, forming a heated working fluid and a heat-depleted exhaust gas. Vaporization of the working fluid in the heat exchanger takes place in a single stage, or multiple stages, producing working fluid vapor which is usually applied to a turbine (not shown) coupled to a generator (not shown). The turbine expands the working fluid vapor and usually drives the generator, producing power from the generator and expanded working fluid vapor from the turbine. A condenser (not shown) condenses the expanded working fluid vapor to condensate. A pump (not shown) returns the condensate to a coil in the at least one heat exchanger to complete the working fluid loop. The heat-depleted exhaust gases exiting the heat exchanger are vented to the atmosphere, and may be treated for environmental purposes before venting.

FIG. 8B illustrates a temperature-heat (T/Q) diagram of the heating of the natural gas and the water of FIG. 8A. As viewed from right to left in FIG. 8B, water temperature increases in the embodiment of FIG. 8A as the water is preheated in heat exchanger 87 (H4). From there, the preheated water enters heat exchanger 45 (H2), and is heated into a water/steam mixture. Although not shown in FIG. 8A, the water/steam mixture may optionally be further heated in heat exchanger 86 (H3), where it picks up additional energy. Next, the water/steam mixture enters the reformer 41, where it becomes a superheated steam which is used to convert at least a portion of the natural gas supplied to the reformer into a syngas/natural gas mixture. A description of this process is provided in the description of the FIG. 4 embodiment, and is not repeated here.

FIG. 8B also illustrates a T/Q diagram of the natural gas in FIG. 8A. Moving from left to right, FIG. 8B shows how at least a portion of the heat from the syngas/natural gas mixture exiting reformer 41 is used to preheat the incoming natural gas. In the diagram shown, the syngas/natural gas mixture exits reformer 41 and enters heat exchanger 44 (H1), which also receives the natural gas prior to the natural gas entering the reformer. Heat exchanger 44 forms a heated compressed hydrocarbon gas (natural gas in the embodiment of FIG. 8A) and a heat-depleted syngas/natural gas mixture. Although not shown in FIG. 8A, the syngas/natural gas mixture can also be passed through heat exchanger 86 (H3), for additional heating of the water/steam mixture. Heat exchanger 86 forms a still further heated water/steam mixture and a still further heat-depleted syngas/natural gas mixture. The syngas/natural gas mixture also passes into heat exchanger 45 (H2). Heat exchanger 45 heats water into a water/steam mixture and further heat depletes the syngas/natural gas mixture. The syngas/natural gas mixture can also be passed through heat exchanger 87 (H4) (not shown in FIG. 8A), to aid with initial water preheating. The number and order of the heat exchange processes described in FIG. 8B is exemplary only, and not limited to what is shown.

FIG. 8C illustrates a variation of the embodiment of the subject matter of FIG. 8A using gas turbine exhaust to heat natural gas and produce steam. In FIG. 8C, the compressed syngas/natural gas mixture from compressor 47 is fed into storage 91. The compressed syngas/natural gas mixture may be taken from storage 91 and placed into natural gas pipeline 13 via compressor 92 (C2). The remaining portions of FIG. 8C are the same as FIG. 8A, and are not described further here.

FIG. 8D illustrates still another variation of the embodiment of FIG. 8C using gas turbine exhaust to heat natural gas and produce steam. In FIG. 8D, the compressed syngas/natural gas mixture from storage unit 91 is further compressed by compressor 92 driven by motor 93 and fed to burner 83 via line 94. Thus, in this embodiment, the compressed syngas/natural gas mixture from reformer 41 is used as fuel in burner 83 in place of natural gas from pipeline 13. Using the syngas/natural gas mixture to fuel burner 83 instead of natural gas from the pipeline reduces or eliminates the need to siphon off a portion of the natural gas from the pipeline to fuel burner 83. This increases the percentage of natural gas taken from pipeline 13 available that is supplied to reformer 41, increasing the efficiency of the reformation process. FIG. 8D also has a line 94A connecting burner 83 to the natural gas pipeline 13 so that, if desired, natural gas can still be supplied to burner 83, alone or in conjunction with the syngas/natural gas mixture. The remaining portions of FIG. 8D are the same as FIGS. 8A and 8C and are not described further here.

FIG. 9 illustrates an exemplary embodiment of a compressor station 95 using hot natural gas from compressor 96 to reduce the heating load of the natural gas in the receiver/reformer. As shown in FIG. 9, in a compressor station 95 with a high compressor ratio upstream of pipeline 13, natural gas from pipeline 13 is compressed and heated in compressor 96 and fed to receiver/reformer 97 without being cooled. Heat generated in compressor station 95 can be used instead of or in addition to solar heat. Heat from compressor station 95 can also be used to preheat natural gas before it enters the solar reformer. Using heat from the compressor station 95 increases the efficiency of the reformation process. Any compressed gas not sent to the receiver/reformer 97 can be cooled in cooler 98 and placed into pipeline 13A. Another way to increase efficiency is to feed the syngas/natural gas mixture into the gas turbine of the compressor station such as from, for example, buffer storage 64 of FIGS. 6 and 7. This helps avoid pumping losses due to the additional energy required to maintain the same pressure in the higher volume of the pipeline.

FIG. 10 illustrates an exemplary embodiment of the subject matter having a split receiver and reformer. Using a split receiver and reformer helps increase overall efficiency. The catalyst bed can be very sensitive to sulfur, for example, which can be present in natural gas. If even a small amount is present, the sulfur can “poisons” the catalyst, which must then be treated to remove the sulfur. Having a split receiver and reformer allows for easier replacement of the catalyst bed, making treatment of the catalyst bed much simpler. In the embodiment shown in FIG. 10, natural gas and water are heated in receiver 1001, which receives at least a portion of its thermal energy from the sun. Water is supplied in an amount that ensures there is at least enough steam to avoid carbonization of the natural gas during the reformation process. The heat from the natural gas exiting receiver 1001 is used as the heat source for the endothermic reforming reaction in reformer 1002. Excess heat remaining after the reaction may then be recovered from the syngas/natural gas mixture exiting the reformer. In this embodiment, the catalyst for the reformation reaction is separate from the receiver, and is located in the reformer. The reformation process is otherwise the same as explained in FIG. 4, and is not repeated here.

It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. Apparatus for generating power using a synthetic gas/natural gas mixture comprising:
a) an expander for expanding a hydrocarbon gas from a pipeline and forming an expanded hydrocarbon gas;
b) supply means for supplying said expanded hydrocarbon gas to a medium temperature reformer;
c) equipment constructed and arranged to reform said expanded hydrocarbon gas from said pipeline into a synthetic gas/natural gas mixture using solar radiation, said equipment including said medium temperature solar reformer and a steam generator generating steam using heat from the medium temperature reformer;
d) further supply means for supplying said synthetic gas/natural gas mixture produced by said equipment to a compressor for compressing said mixture and forming a compressed mixture; and
e) a still further supply means for supplying said compressed mixture to said pipeline.

2. The apparatus of claim 1, wherein the synthetic gas/natural gas mixture comprises up to about 304 synthetic gas.

3. The apparatus of claim 1, wherein the medium temperature solar reformer operates at a temperature between about 500° C. and about 600° C.

4. A method of generating power using synthetic gas comprising the steps of:
a) expanding a hydrocarbon gas from a pipeline to form an expanded hydrocarbon gas;
b) supplying said expanded hydrocarbon gas to a medium temperature reformer;
c) reforming at least a portion of the expanded hydrocarbon gas into a synthetic gas/natural gas mixture using equipment constructed and arranged to reform said hydrocarbon gas from said pipeline into a synthetic gas/natural gas mixture using solar radiation, said equipment including said medium temperature solar reformer and a steam generator generating steam using heat from the medium temperature reformer;
d) compressing the synthetic gas/natural gas mixture to form a compressed mixture; and
e) supplying the compressed mixture to said pipeline.

5. The method of claim 4, wherein at least a portion of the hydrocarbon material feedstock is reformed into a synthetic gas/natural gas mixture comprising up to about 30% synthetic gas.

6. The method of claim 4, wherein the medium temperature solar reformer is operated at a temperature between about 500° C. and about 800° C.

7. Apparatus for generating power using a synthetic gas/natural gas mixture comprising:
a) a compressor for compressing a hydrocarbon gas from a pipeline and forming a compressed hydrocarbon gas;
b) supply means for supplying said compressed hydrocarbon gas from the compressor to a medium temperature solar reformer;
c) equipment constructed and arranged to solar reform said compressed hydrocarbon gas from said pipeline into a synthetic gas/natural gas mixture, said equipment including said medium temperature solar reformer and a steam generator generating steam using heat from the reformer equipment;
d) further supply means for supplying said synthetic gas/natural gas mixture produced by said equipment to an expander to produce an expanded synthetic gas/natural gas mixture; and
e) a still further supply means for supplying said expanded mixture to said pipeline.

8. Apparatus according to claim 7 further comprising a first heat exchanger for receiving said compressed hydrocarbon gas and said synthetic gas/natural gas mixture and forming a heated compressed hydrocarbon gas and a heat-depleted synthetic gas/natural gas mixture.

9. Apparatus according to claim 8 further comprising a second heat exchanger for receiving and pre-heating said compressed hydrocarbon gas prior to being fed to said first heat exchanger.

10. A method for generating power using a synthetic gas/natural gas mixture comprising the steps of:
a) compressing a hydrocarbon gas from a pipeline to form a compressed hydrocarbon gas;
b) supplying said compressed hydrocarbon gas to a medium temperature solar reformer,
c) reforming at least a portion of the compressed hydrocarbon gas into a synthetic gas/natural gas mixture using equipment constructed and arranged to reform said hydrocarbon gas from said pipeline into a synthetic gas/natural gas mixture using solar radiation, said equipment including said medium temperature solar reformer and a steam generator generating steam using heat from the medium temperature reformer;
d) expanding the synthetic gas/natural gas mixture to form an expanded mixture; and
e) supplying the expanded mixture to said pipeline.

11. The method of claim 10, wherein at least a portion of the hydrocarbon material feedstock is reformed into a synthetic gas/natural gas mixture comprising up to about 30% synthetic gas.

12. The method of claim 10, wherein the medium temperature solar reformer is operated at a temperature between about 500° C. and about 800° C.

13. The apparatus of claim 1, further comprising a first heat exchanger for receiving said expanded hydrocarbon gas and said synthetic gas/natural gas mixture and forming a heated expanded hydrocarbon gas and a heat-depleted synthetic gas/natural gas mixture.

14. The apparatus of claim 1, further comprising a second heat exchanger for receiving and pre-heating said expanded hydrocarbon gas prior to being fed to said first heat exchanger.

15. The apparatus of claim 14, further comprising an air compressor coupled to a turbine operated by a burner.

16. The apparatus of claim 15, further comprising a third heat exchanger for receiving hot turbine exhaust gases and expanded hydrocarbon gas and forming a heated expanded hydrocarbon gas and a heat-depleted turbine exhaust.

17. The apparatus of claim 16, further comprising a fourth heat exchanger for receiving heat-depleted turbine exhaust and water and forming a preheated water and steam mixture and a further heat-depleted turbine exhaust.

18. The apparatus of claim 15, further comprising a turbine drive shaft and a second compressor, the turbine drive shaft coupling the second compressor to the turbine.

19. The apparatus of claim 15, further comprising a synthetic gas/natural gas mixture storage unit.

20. The apparatus of claim 19, further comprising a supply means for supplying the stored mixture from the storage unit to the turbine burner.
